(19) United States
(12) Patent Application Publication
(10) Pub. No.: US 2005/0172006 A1
(43) Pub. Date: Aug. 4, 2005

(54) Device for data transfer between information appliance and MP3 playing unit

(76) Inventor: Yueh Wen Hsiang, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/768,054

(22) Filed: Feb. 2, 2004

(51) Int. Cl. G06F 15/16

(52) U.S. Cl. 709/217; 709/219; 709/222

(57) ABSTRACT

A device for data transfer between an information appliance and an MP3 playing unit MP3 is described. The device has an MP3 playing unit, a first radio module, an information appliance and a second radio module. The first radio module is disposed inside or connected externally to the MP3 playing unit and connects with a digital signal processor inside the MP3 playing unit. The second radio module 4 is disposed inside the information appliance and connects with the control circuit of the information appliance. Thereby, the device can transfer data or voice signals between the information appliance and MP3 playing unit in a wireless manner. The device can also allow a user to hear directly a voice message output from the information appliance via the MP3 playing unit.

### FIELD OF THE INVENTION

The present invention is directed to a device for data transfer between an information appliance and an MP3 playing unit, and more particularly, to a device that can use an MP3 playing unit to control the switch, volume or the like of an information appliance via Bluetooth transmission technique.

### BACKGROUND OF THE INVENTION

MP3, which is the third layer voice compression standard of Motion Picture Experts Group (MPEG), can compress files of a music compact disk (CD) to one-tenth or twelfth the original size thereof. Even though compressed, the sound quality of MP3 files is still quite similar to that of the music CD. Hence, many MP3 related products have already appeared on the market, such as, for example, MP3 players and the MP3 Walkman.

On the other hand, Bluetooth is a radio transmission technique, which can connect together a computer, personal digital assistant (PDA), mobile phone, printer, scanner, digital camera and household appliance in a short-distance and wireless manner. Hence, its products are more and more popular.

However, a device for data transfer between an information appliance and an MP3 playing unit has not yet appeared on the market. Accordingly, the present invention aims to develop this kind of product.

### SUMMARY OF THE INVENTION

An objective of the present invention is to provide a device for data transfer between an information appliance and an MP3 playing unit, which can employ the Bluetooth transmission technique to transfer data between the information appliance and MP3 playing unit in a wireless manner.

Another objective of the present invention is to provide a device for data transfer between an information appliance and an MP3 playing unit, which can employ the Bluetooth transmission technique to allow a user to hear a voice message output from the information appliance via the MP3 playing unit.

For reaching the objective above, the present invention provides a device for data transfer between an information appliance and an MP3 playing unit. The data transfer device includes an MP3 playing unit having a digital signal processor respectively connecting with function keys used for inputting commands and a first radio module and an information appliance having a second radio module connecting with a control circuit used for turning on/off a switch, adjusting volume or tuning a channel. The digital signal processor is used to send the commands to the second radio module of the information appliance via the first radio module to provide a message for the control circuit to control the information appliance, or used to receive voice signals via the first and second radio modules and convert the voice signals into a voice.

The information appliance mentioned above can be a television, a stereo or a multimedia related product. The information appliance also has a connecting unit for the second radio module to connect externally and to electrically connect with the control circuit. The information appliance further has a memory unit, which connects with the control circuit, for storing data or programs.

The MP3 playing unit mentioned above further has a memory unit, which connects with the digital signal processor, for storing data or programs.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a device for data transfer between an information appliance and an MP3 playing unit in accordance with the present invention;

FIG. 2 is a circuit block diagram of the device for data transfer between an information appliance and an MP3 playing unit in accordance with the present invention; and

FIG. 3 is a schematic diagram of another embodiment in accordance with the present invention.

### DETAILED DESCRIPTION

The present invention is a device for data transfer between an information appliance and an MP3 playing unit, which employs the Bluetooth transmission technique to transfer data or voice signals between the information appliance and MP3 playing unit without any electric wire.

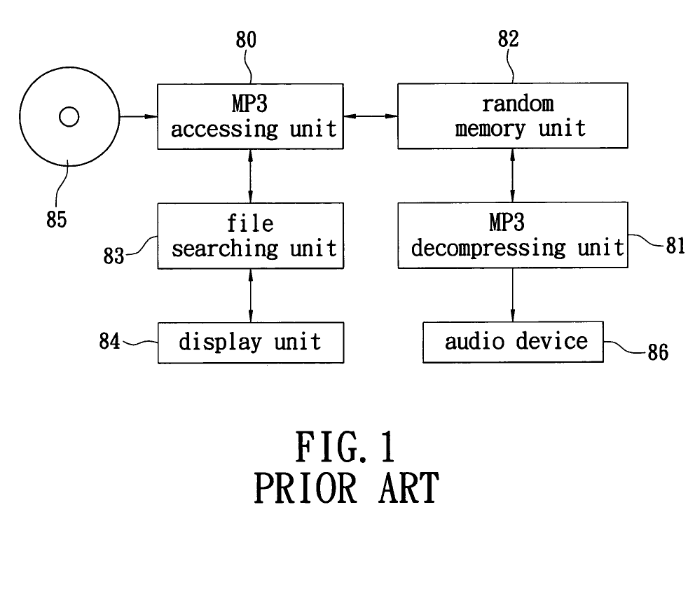

Reference is made to FIG. 1, which is a schematic diagram of the present invention. Therein, the first radio module 2 is connected with an MP3 playing unit 1 externally and its internal circuit. The second radio module 4 is disposed inside an information appliance 3 and connected with its internal circuit. The first radio module 2 and second radio module 4 are both Bluetooth modules.

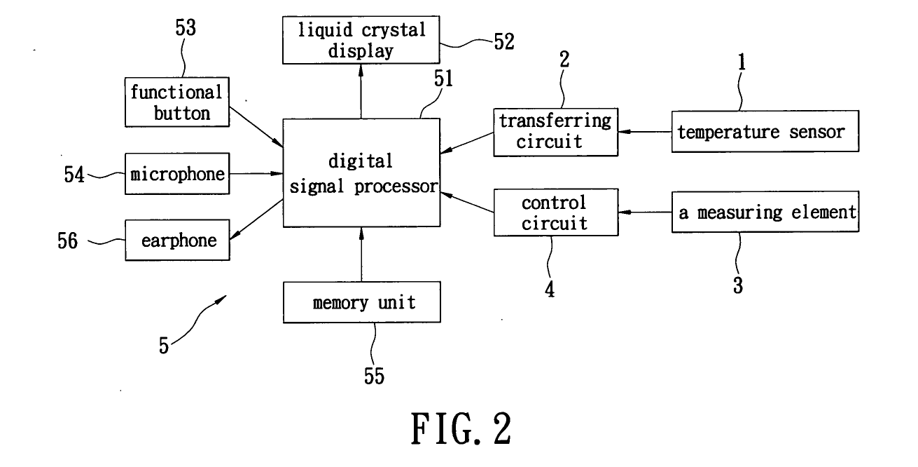

Reference is made to FIG. 2, a circuit block diagram of the present invention, which includes the MP3 playing unit 1, first radio module 2, information appliance 3 and second radio module 4. Therein, the MP3 playing unit 1 is used to read storage media with MP3 files, decompress the MP3 files and convert the MP3 files into analog signals to output voice signals. The MP3 playing unit 1 is also used to perform a related message according to input commands. The circuit of the MP3 playing unit 1 primarily has a digital signal processor 11. The digital signal processor 11 is connected with function keys 12 for inputting commands, a liquid crystal displayer (LCD) 13, a microphone 14, a memory unit 15 for storing data and programs, a speaker 16 and an earphone 17. The digital signal processor 11 performs related functions according to the input commands from the function keys 12 and the voice signals from the microphone 14 or the MP3 files stored in the memory unit 15 so as to show the related message on the LCD 13 and send the decompressed analog voice signals to the earphone 17.

The first radio module 2 can be disposed inside or connected externally to the MP3 playing unit 1. The first radio module 2 also connects with the digital signal processor 11 to receive the voice data sent from the information appliance 3 or send the decompressed data or voice signals from the MP3 playing unit 1 to the information appliance 3. In the embodiment of the present invention, the first radio module 2 is a Bluetooth module, which has a chip set used to transmit digital data or voice signals on the bandwidth centered at 2.45 MHz.

In the embodiment of the present invention, the information appliance 3 can be a television, a stereo or a multimedia-related product. Its circuit primarily includes a control circuit 31, which connects with a switch 32, and an output circuit 33 for adjusting the volume and a memory unit 34 for storing data and programs. The control circuit 31 can turn on/off the switch 32, adjust the volume or tune the channel according to the input command.

The second radio module 4 respectively connects with the control circuit 31 and the output circuit 33 to receive the message sent from the first radio module 2 and pass the message to the control circuit 3 for further processing. The second radio module 4 can also pass the voice signals sent from the output circuit 33 to the first radio module 2 of the MP3 playing unit 1 and then pass the voice signals to the digital signal processor 11 for converting them into voice and passing the same to the earphone 17. In the embodiment of the present invention, the second radio module 4 is a Bluetooth module, which has a chip set used to transmit digital data or voice signals on the bandwidth centered at 2.45 MHz.

When the second radio module 4 sends the voice signals output from the information appliance 3 to the first radio module 2, the digital signal processor 11 of the MP3 playing unit 1 converts the voice signals into a voice and sends the same to the earphone 17.

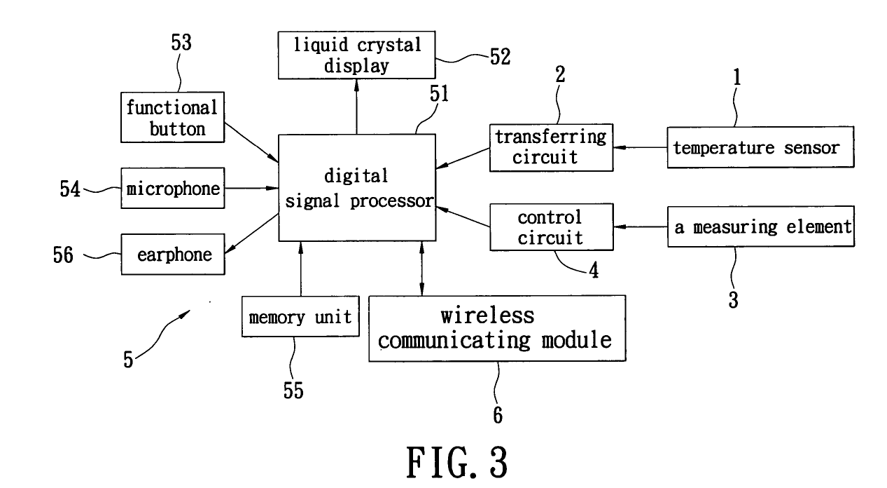

Reference is made to FIG. 3, which is a schematic diagram of another embodiment complying with the present invention. The information appliance 3 further has a connecting unit 35 for the second radio module 4 to connect externally and electrically with the control circuit 31. Thereby, the voice signals output from the information appliance 3 can be sent to the first radio module 2 via the second radio module 4 to use the digital signal processor 11 of the MP3 playing unit 1 to convert the voice signals into a voice and send the same to the earphone 17.

Summing up, the present invention can employ the Bluetooth transmission technique to transfer data between the information appliances and MP3 playing unit over a short distance in a wireless manner. The present invention can also allow a user to hear the voice message output from the information appliance via the MP3 playing unit.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A device for data transfer, comprising:
an MP3 playing unit having a digital signal processor respectively connecting with function keys used for inputting commands and a first radio module; and
an information appliance having a second radio module connecting with a control circuit used for turning on/off a switch, adjusting volume or tuning a channel;
wherein the digital signal processor is used to send the commands to the second radio module of the information appliance via the first radio module to provide a message for the control circuit to control the information appliance, or used to receive voice signals via the first and second radio modules and convert the voice signals into a voice.

2. The device as claimed in the claim 1, wherein the information appliance is a television, a stereo or a multimedia-related product.

3. The device as claimed in the claim 1, wherein the information appliance has a connecting unit for the second radio module to connect externally and electrically with the control circuit, whereby the voice signals output from the information appliance are sent to the first radio module via the second radio module to use the digital signal processor of the MP3 playing unit to convert the voice signals into a voice.

4. The device as claimed in the claim 1, wherein the information appliance further has a memory unit, which connects with the control circuit, for storing data or programs.

5. The device as claimed in the claim 1, wherein the first radio module is disposed inside the MP3 playing unit.

6. The device as claimed in the claim 1, wherein the first radio module connects with the MP3 playing unit externally.

7. The device as claimed in the claim 1, wherein the MP3 playing unit further has a memory unit connected to the digital signal processor for storing data or programs.
